(19) United States
(12) Patent Application Publication
(10) Pub. No.: US 2025/0297814 A1
(43) Pub. Date: Sep. 25, 2025

(54) A PHASE CHANGE MATERIAL (PCM) MODULE FOR A HEAT EXCHANGER APPARATUS FOR TEMPERATURE REGULATION IN A BUILDING

(71) Applicant: Syddansk Universitet, Odense M (DK)

(72) Inventor: Mads Høi Rasmussen, Odense M (DK)

(73) Assignee: Syddansk Universitet, Odense M (DK)

(21) Appl. No.: 19/112,402

(22) PCT Filed: Sep. 19, 2023
(86) PCT No.: PCT/EP2023/075707

§ 371 Date: Mar. 17, 2025

(30) Foreign Application Priority Data
Sep. 20, 2022 (EP) 22196559.3

(51) Int. Cl. F28D 20/00

(52) U.S. Cl. CPC F28D 20/0034

(57) ABSTRACT

A Phase Changing Material module for a heat exchanger apparatus has a first plate shell and a second plate shell, both shells having an undulated wave surface with a smooth, periodic oscillation. Both plates have a rectangular peripheral edge portion. The first and second plate shells are joined together along their peripheral edges to form an internal volume which is filled with a phase changing material.

### CROSS-REFERENCE TO RELATED APPLICATIONS

The present application is the National Phase entry of International Patent Application No. PCT/EP2023/075707, filed Sep. 19, 2023, which claims priority to European Patent Application No. 22196559.3, filed Sep. 20, 2022, the entire contents of both are hereby incorporated by reference into this application.

### TECHNICAL FIELD

The present invention relates to a Phase Changing Material module for a heat exchanger apparatus and an apparatus with such Phase Changing Material modules.

### BACKGROUND

In the art it is known to use phase change materials (PCM) in systems for temperature regulation in a room in a building.

A phase change material (PCM) is a substance which releases/absorbs sufficient energy at phase transition to provide useful heat/cooling. Generally the transition will be from one of the first two fundamental states of matter—solid and liquid—to the other. By melting and solidifying at the phase change temperature (PCT), a PCM is capable of storing and releasing large amounts of energy compared to sensible heat storage. Heat is absorbed or released when the material changes from solid to liquid and vice versa or when the internal structure of the material changes; PCMs are accordingly referred to as latent heat storage (LHS) materials.

WO 2013/019113 A1 discloses a climate system for buildings and comprises heat storage with a heat exchanger assembly comprising a plurality of plate shaped phase change material (PCM) units. In the system air flows through a channel wherein a heat exchanger unit is mounted. This unit comprise a series of PCM units, and in some embodiments disclosed in WO 2013/019113 A1, the plurality of PCM units are assembled as a box-like unit and mounted in an inclined configuration in the channel with an angle between 5 and 45 degrees with respect to the incoming air direction.

WO 2013/191554 A2 discloses a container for PCM, a PCM unit and PCM module having a series of PCM units and a climate system comprising a PCM module. The PCM units are arranged such that the incoming air flow is directed around the PCM units in a particular way.

WO 2010/092391 A1 discloses a fluid conditioning arrangement with PCM modules for ambient temperature control in buildings.

A large amount of electricity is consumed for temperature regulation of buildings around the world, either for heating the building or ventilating and cooling the building. The concept of utilising PCM based systems are known, so that energy can be stored and used for cooling the building without using electricity. However, these known systems are found to be bulky in design and somewhat inefficient and may be difficult to maintain.

It is an object of the present invention to provide an improvement of the prior art PCM heat exchangers. In particular, it is an object to provide PCM modules suitable for such PCM heat exchanger, which ensures an airflow through the heat exchanger without much pressure loss and with a laminar airflow passing the PCM modules to ensure that the phase change occurs as simultaneous as possible for all PCM modules in the heat exchanger.

### SUMMARY

The invention comprises in a first aspect a Phase Changing Material module for a heat exchanging device, wherein the module comprises a first plate shell and a second plate shell, both shells having an undulated wave surface with a smooth, periodic oscillation, and wherein both said plates have a rectangular peripheral edge portion; wherein said first and second plate shells are joined together along their peripheral edges to form an internal volume which is filled with a phase changing material.

By the invention, there is achieved a Phase Changing Material module with a large surface so that heat from the air passing through a heat exchanger with such modules fitted can be extracted and the phase change of the material in the PCM modules is achieved quickly and uniformly for all the PCM modules in the heat exchanger. Furthermore, it is found advantageous that the modules with the wave-shaped surfaces can be stacked in a manner so that air channels with an even width and with an undulating form are created. This allows for an airflow across the modules which is laminar or at least substantially laminar as well as an airflow which has a large contact surface with the PCM modules.

In the preferred embodiment of the PCM module of the invention, the first plate shell is an upper plate shell and the second plate shell is a lower plate shell. This means that the PCM modules can be stacked in a horizontal orientation of all of the PCM modules.

In a preferred embodiment, the undulated wave surface is a substantially sinusoidal form with the same amplitude and wave length (or period of the wave) and wherein sinusoidal form of the first and second plate shells are relatively phase shifted by a predetermined distance of up to a distance of half the wave length. By this same wave form on the upper and lower sides of the PCM modules, the PCM modules can be stacked either directly above each other if the phase shift distance is half the wave length or in a parallelogram stacked shape if the phase shift length is slightly less than the half wave length. By the relatively phase shifting between the two shell plates by a small distance of up to a distance of half the wave length, the wedge-shaped inlet and outlet sections can be formed as well as the airflow channels with an even width and with an undulating form are also formed. Thus, by the small relative phase-shift of the waveforms of the upper and lower shell plates the advantageous geometric characteristics of the inlet and outlet sections as well as the airflow channels are achieved.

Advantageously, the plate shells are made of a polymer material, such as polyethylene, in particular high density polyethylene (HDPE). Hereby, any risk of corrosion due to the PCM material contained in the PCM modules is avoided. The phase change materials may often be salt hydrates which can be very corrosive if the modules are made of metal. The plastic material eliminates this corrosion risk. Furthermore, it is advantageous, in particular if the HDPE or the like is used as this material has good heat transferring properties and are weldable, just as the material is inexpensive to obtain. The shells may be manufactured by injection moulding or other types of moulding to produce the half-shells that can then be joined together and filled with a suitable phrase change material that is adapted to have its phase change temperature at the desired temperature.

The first and second plate shells are preferably provided with circumferential rims and the shells are joined together each other along said rims. Accordingly, the first and second plate shells are welded together.

By the second aspect of the invention there is provided an apparatus for temperature regulation in a building, comprising an inlet section receiving an airflow in a first direction, and an outlet section with a heat exchange section therebetween, wherein said inlet section has an inlet channel, which is provided with a side-opening towards the heat exchange section, and said heat exchange section comprising a plurality of generally plate-shaped phase change material (PCM) modules mounted in a stacked formation forming a series of air channels between said PCM modules extending from the inlet section to the outlet section, and wherein the air channels are formed between the PCM modules and so that the airflow is gradually redirected from the inlet section and into the air channels of the heat exchange section, whereby the airflow is subjected to the temperature of the PCM modules before exiting the heat exchange section into the outlet section, wherein the plate-shaped phase change material (PCM) modules are provided in parallel in the stacked formation and wherein the PCM modules are provided with undulated wave surface with a smooth, periodic oscillation such that the air channels are being formed as serpentine-shaped air flow channels of essentially even width are formed between said PCM modules.

In the apparatus according to the second aspect, the PCM modules in the stacked formation of the heat exchange section are modules according to the first aspect of the invention.

In a preferred embodiment, the serpentine-shaped air channels formed between the stacked PCM modules are sinusoidal air flow channels of essentially even width are formed between said PCM modules. This ensures a substantially laminar airflow through the air channels.

In order to ensure an even distribution of air in the paralleled provided airflow channels, it is found advantageous that the inlet channel has a wedge-shaped inlet channel having a wide opening at an air inlet and a gradually narrowing cross-section downstream thereof.

By the second aspect of the invention there is provided a PCM based cooling system in the form of a heat exchanger with PCM plate modules that has low pressure drop meaning low additional energy consumption used to guide the air through the heat exchanger. The heat exchanger has very even airflow offering a system that provide effective cooling until all energy stored in the PCM plate modules is dispatched. The heat exchanger has a space-saving compact design allows for easy integration and has a modular design that can fit small and large buildings easily. Moreover, it has fine serviceability which allows for easy cleaning of the PCM containers/plate modules.

During the day outside air of an elevated temperature relative to the phase change temperature (PCT) of the PCM modules may be drawn into the apparatus and cooled before entering the building by melting the PCM of the plate modules. During the night, where the outside temperature is lower than the PCT and then the PCM modules heats up the incoming air to near the phase change temperature as the PCM solidifies.

In some preferred embodiments, the phase change material of the PCM modules is adapted for phase change at 10°-25° Celsius. The particular temperature for the phase change, the phase change temperature (PCT) may be chosen in accordance with the specific requirements for the climate in the building in which the heat exchange system is to be installed. Since the phase change temperature is material specific, accordingly the specific material in the PCM plate modules is also to be chosen for the specific use of the heat exchanger.

### BRIEF DESCRIPTION OF THE DRAWINGS

In the following the invention is described in more detail with reference to the accompanying drawings, in which:

FIG. 1 is a schematic side view of a heat exchanger apparatus according to an embodiment of the invention;

FIG. 2 is a perspective view of a heat exchanger apparatus according to an embodiment of the invention with side cover removed;

FIG. 3 is a detailed view of the mounting of the PCM plate modules in the heat exchanger apparatus of FIG. 2;

FIG. 4 is a perspective view of a PCM module according to a preferred embodiment of the invention; and

FIG. 5 is the same PCM module as in FIG. 4 in an exploded view.

### DETAILED DESCRIPTION

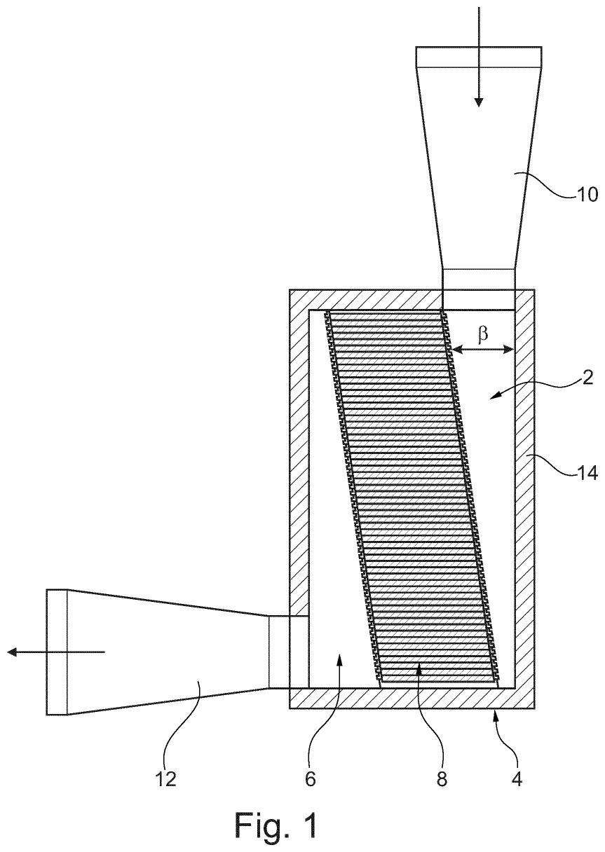

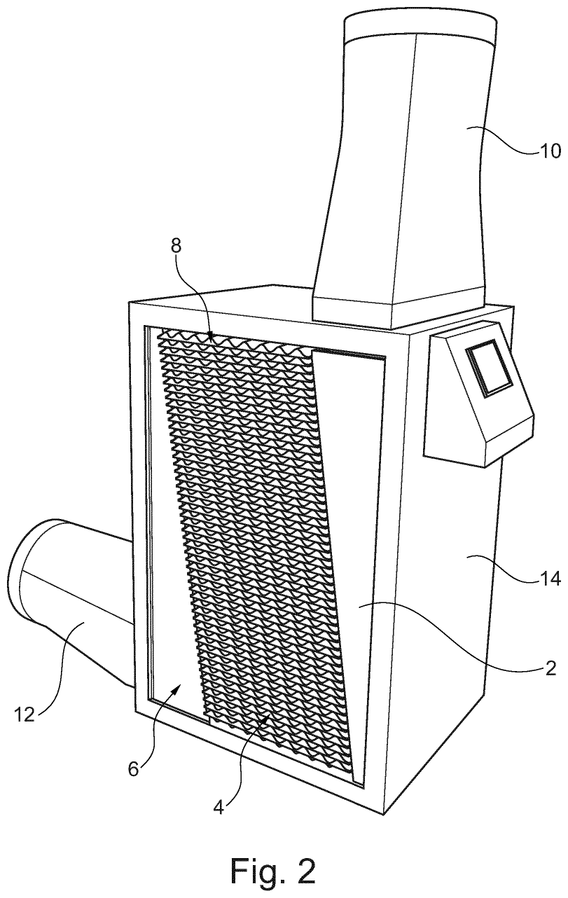

With reference to FIGS. 1-3, an apparatus for temperature regulation in a building according to an embodiment of the invention is shown. The apparatus comprises an inlet section 2 receiving an airflow of incoming air in a first direction, and an outlet section 6 with a heat exchange section 4 there between. These sections—i.e. the inlet 2, heat exchanger 4 and outlet 6—are arranged in a housing 14, which has a compact box shape (see FIG. 2). On the top of the housing 14 there is provided an air inlet 10 guiding the incoming air into the inlet section 2, which has a wedge-shaped inlet channel having a wide opening at an air inlet 10 and a gradually narrowing cross-section downstream thereof. The inlet channel 2 is provided with a side-opening towards the heat exchange section 4.

The heat exchange section 4 comprises a plurality of plate-shaped phase change material (PCM) modules 8 mounted in a stacked formation forming a series of air channels 40 between said PCM modules extending from the inlet section to the outlet section are formed between the PCM modules and so that the airflow is gradually redirected from the inlet section and into the air channels of the heat exchange section, whereby the airflow is subjected to the temperature of the PCM modules before exiting the heat exchange section into the outlet section.

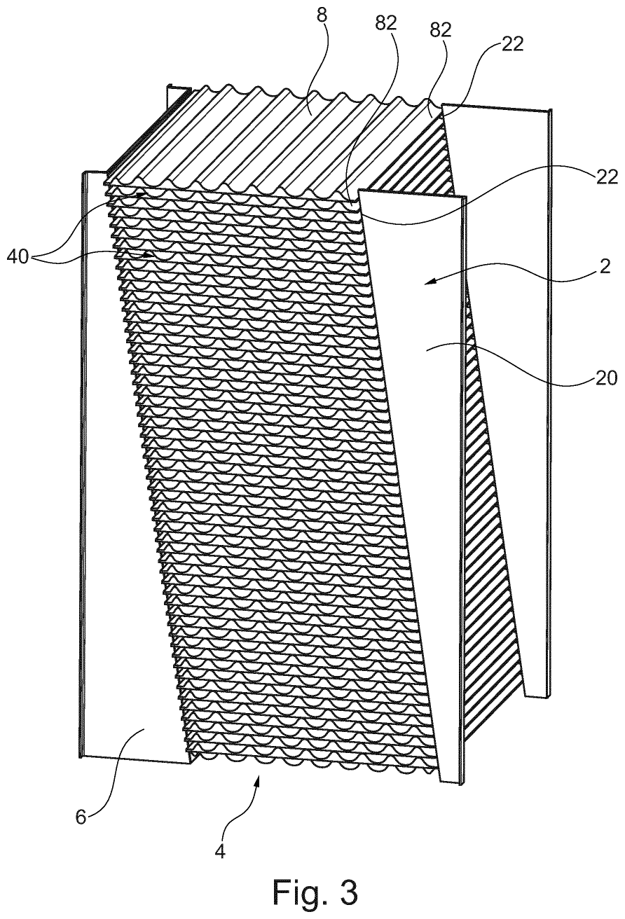

As shown in FIGS. 2 and 3, the plate-shaped phase change material (PCM) modules 8 are provided with circumferential rims 82 and are accommodated in a rack 20 formed at the side of the inlet section 2 and at the side of the outlet section (not shown in FIG. 3). The rack 20 comprises rail supports 22 for receiving the rims 82 of the PCM modules 8 so that the PCM modules 8 are accommodated with air channels 40 between the modules 8 in the stack. As shown in the figures, the air channels 40 between the PCM plate modules 8 are substantially parallel and providing an airflow in a direction substantially perpendicular to the first airflow direction of the inlet 2.

As shown in the figures, the plurality of plate-shaped phase change material (PCM) modules 8 are mounted in an inclined stacked formation with a shape of a parallelogram. By the relatively phase shifting between the two shell plates by a small distance of up to a distance of half the wave length, the wedge-shaped inlet and outlet sections can be formed as well as the airflow channels with an even width and with an undulating form are also formed. Thus, by the small relative phase-shift of the waveforms of the upper and lower shell plates the advantageous geometric characteristics of the inlet and outlet sections as well as the airflow channels are achieved. Accordingly, a particularly compact design of the PCM heat exchanger apparatus is achieved as the wedge-shaped inlet section 2 and outlet section 6 together with the parallelogram-shaped heat exchanger section form the compact rectangular box-shape.

The inlet section and the outlet section are wedge-shaped with an inclination angle B, which is preferably between 3° and 25° depending on the overall size of the heat exchanger apparatus. The inlet section 2 acts as a manifold and the angle B is particularly selected in order to ensure an evenly distributed airflow through all of the air channels 40 between the PCM plate modules 8 so that all PCM modules are exposed to the airflow evenly and thus exposed to air temperature evenly so that they all change their phase substantially simultaneously. Thus design prevents an uneven temperature distribution along the PCM modules 8, which is to be avoided as otherwise a heated PCM modules 8 may heat neighbouring PCM modules 8 and cause the PCM modules to undergo a phase change and thereby deteriorate the overall cooling effect of the heat exchanger.

As mentioned above, the housing 14 is provided with side covers at least on one side, but preferably on each side (not shown). The side cover retains the plate-shaped PCM modules 8 in said rack and provides an airtight seal between the plate-shaped PCM modules 8. As indicated in FIG. 2, the plate modules 8 can slide in the rack so that the modules 8 are easy to place in the rack and easy to remove for service or replacement.

All of the PCM plate modules 8 can thus easily be exchanged for instance if the heat exchanger is to be configured for a specific temperature. The phase change material of the PCM modules has a specific phase change temperature (PCT). By the invention it is currently preferred that the modules are adapted for undergoing a phase change at 10°-25° Celsius. The particular temperature for the phase change, the phase change temperature (PCT) may be chosen in accordance with the specific requirements for the climate in the building in which the heat exchange system is to be installed. Since the phase change temperature is material specific, accordingly the specific material in the PCM plate modules is also to be chosen for the specific use of the heat exchanger.

An air flow generator (not shown), such as an air blower, is provided for controlling an airflow into the inlet channel 2. This air flow generator may be provided upstream the air inlet section 2 in the inlet duct 10 for providing an airflow into the inlet channel 2. Alternatively or additionally, the air flow generator may be provided downstream the outlet section 6 in an outlet duct 12 for providing an airflow through the heat exchanger apparatus.

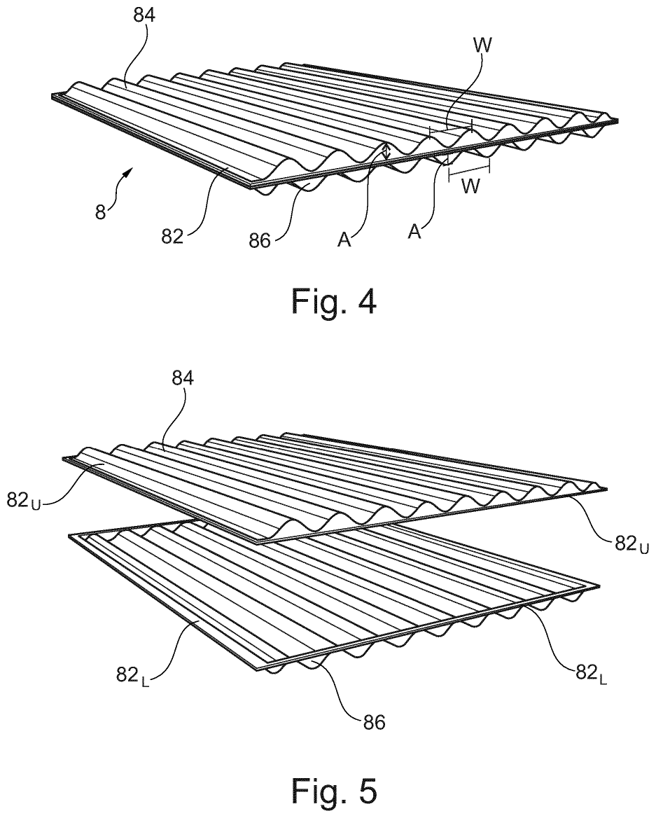

In FIGS. 4 and 5 an embodiment of a PCM module according to a preferred embodiment of the invention is shown. The PCM module 8 comprises a first, upper plate shell 84 and a second, lower plate shells 86. The first and second plate shells 84, 86 have a rectangular peripheral edge portion 82 and are joined together along their peripheral edges 82U, 86L to form an internal volume. The first and second plate shells 84, 86 are joined together each other along the peripheral edges 82U, 86L. The internal volume is filled with a phase changing material. Both the upper plate shell and the lower plate shall are provided with an undulated wave surface with a smooth, periodic oscillation, and wherein both said plates.

The undulated wave surface is a substantially sinusoidal form with the same amplitude A and wave length W and wherein sinusoidal form of the first and second plate shells are relatively phase shifted by a predetermined distance of up to a distance of half the wave length.

The plate shells 84, 86 are made of a polymer material, such as polyethylene, in particular high density polyethylene (HDPE) and are welded together. This allows for an easy and inexpensive manufacturing of the plates.

As shown in FIGS. 2 and 3, the heat exchanger apparatus for temperature regulation in a building, comprises in the heat exchanging section 4 a plurality of generally plate-shaped phase change material (PCM) modules 8 mounted in a stacked formation forming a series of air channels 40 between said PCM modules 8 extending from the inlet section 2 to the outlet section 6. The air channels 40 are formed between the PCM modules 8. and so that the airflow is gradually redirected from the inlet section 2 and into the air channels 40 of the heat exchange section 4, whereby the airflow is subjected to the temperature of the PCM modules 8 before exiting the heat exchange section 4 into the outlet section 6. The plate-shaped phase change material (PCM) modules 8 are provided in parallel in the stacked formation and the PCM modules 8 are provided with the undulated wave surface with a smooth, periodic oscillation so that the air channels 40 formed are formed between said PCM modules with a serpentine shaped and with essentially even width. These serpentine-shaped air channels 40 formed between the stacked PCM modules 8 are sinusoidal-formed air flow channels 40 of essentially even width.

Above, the invention is described with reference to some currently preferred embodiments. However, by the invention it is realised that other embodiments and variants may be provided without departing from the scope of the invention as defined in the accompanying claims.

Thus, although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A Phase Changing Material module for a heat exchanger apparatus, wherein the module comprises:
a first plate shell and a second plate shell, both shells having an undulated wave surface with a smooth, periodic oscillation, and wherein both said plates have a rectangular peripheral edge portion;
wherein said first and second plate shells are joined together along their peripheral edges to form an internal volume which is filled with a phase changing material.

2. The Phase Changing Material module according to claim 1. wherein the first plate shell is an upper plate shell and the second plate shell is a lower plate shell.

3. The Phase Changing Material module according to claim 1, wherein the undulated wave surface is a substantially sinusoidal form with the same amplitude and wave length (or period) and wherein sinusoidal form of the first and second plate shells are relatively phase shifted by a predetermined distance of up to a distance of half the wave length.

4. The Phase Changing Material module according to claim 1, wherein the first and second plate shells are provided with peripheral edges and the shells are joined together each other along said edges.

5. The Phase Changing Material module according to claim 1, wherein the plate shells are made of a polymer material, such as polyethylene, in particular high density polyethylene (HDPE).

6. The Phase Changing Material module according to claim 1, wherein the first and second plate shells are welded together.

7. An apparatus for temperature regulation in a building, comprising an inlet section receiving an airflow in a first direction, and an outlet section with a heat exchange section therebetween, wherein:
said inlet section has an inlet channel, which is provided with a side-opening towards the heat exchange section, and
said heat exchange section comprising a plurality of generally plate-shaped phase change material (PCM) modules mounted in a stacked formation forming a series of air channels between said PCM modules extending from the inlet section to the outlet section, and wherein the air channels are formed between the PCM modules and so that the airflow is gradually redirected from the inlet section and into the air channels of the heat exchange section, whereby the airflow is subjected to the temperature of the PCM modules before exiting the heat exchange section into the outlet section, wherein the plate-shaped phase change material (PCM) modules are provided in parallel in the stacked formation and wherein the PCM modules are provided with undulated wave surface with a smooth, periodic oscillation such that the air channels are being formed as serpentine-shaped air flow channels of essentially even width are formed between said PCM modules.

8. The apparatus according to claim 7, wherein the PCM modules in the stacked formation of the heat exchange section are modules each comprising:
a first plate shell and a second plate shell, both shells having an undulated wave surface with a smooth, periodic oscillation, and wherein both said plates have a rectangular peripheral edge portion;
wherein said first and second plate shells are joined together along their peripheral edges to form an internal volume which is filled with a phase changing material.

9. The apparatus according to claim 7, wherein the serpentine-shaped air channels formed between the stacked PCM modules are sinusoidal air flow channels of essentially even width are formed between said PCM modules.

10. The apparatus according to claim 7, wherein the inlet channel has a wedge-shaped inlet channel having a wide opening at an air inlet and a gradually narrowing cross-section downstream thereof.

11. The apparatus according to claim 10, wherein the inlet channel has an inclination angle β, preferably β being between 3° and 25°.

12. The apparatus according to claim 7, wherein the air channels between the PCM modules are substantially parallel and providing an airflow in a direction substantially perpendicular to the first airflow direction of the inlet.

13. The apparatus according to claim 7, wherein the outlet section is wedge-shaped with an outlet channel at the wide end of said wedge-shaped outlet section, said outlet section preferably having an inclination angle β, and preferably β being between 3° and 25°.

14. The apparatus according to claim 7, wherein an air flow generator, such as an air blower, is provided for controlling an airflow into the inlet channel.

15. The apparatus according to claim 14, wherein the air flow generator is provided upstream the air inlet section for providing an airflow into the inlet channel.

16. The apparatus according to claim 14, wherein the air flow generator is provided downstream the outlet section for providing an airflow into the inlet channel.

17. The apparatus according to claim 14, wherein the air flow generator is capable of reversing the airflow through the heat exchanger.

18. The apparatus according to claim 7, wherein the apparatus is accommodated in a box-shaped housing and wherein the plurality of plate-shaped phase change material (PCM) modules are mounted in an inclined stacked formation with a shape of a parallelogram.

19. The apparatus according to claim 7, wherein the plate-shaped phase change material (PCM) modules are provided with circumferential rims and are accommodated in a rack, where the side of the inlet section and the side of the outlet section are provided with rail supports for receiving the rims of the PCM modules.

20. The apparatus according to claim 19, wherein the housing is provided with side covers that retain the plate-shaped PCM modules in said rack and provides an airtight seal between the plate-shaped PCM modules.

21. The apparatus according to claim 7, wherein the phase change material of the PCM modules is adapted for phase change at 10°-25° Celsius.
